(19) United States
(12) Patent Application Publication
(10) Pub. No.: US 2013/0294978 A1
(43) Pub. Date: Nov. 7, 2013

(54) CHEMICAL DISSOLVING DISPENSER

(71) Applicants: Reynato Mariano, Ajax (CA); Patrick Chebi, Jacksonville, FL (US); Russ Jerusik, Newark, DE (US); Richard E. Haas, Milford, OH (US); Jason A. McDaniel, Independence, KY (US)

(72) Inventors: Reynato Mariano, Ajax (CA); Patrick Chebi, Jacksonville, FL (US); Russ Jerusik, Newark, DE (US); Richard E. Haas, Milford, OH (US); Jason A. McDaniel, Independence, KY (US)

(21) Appl. No.: 13/463,348

(22) Filed: May 3, 2012

(51) Int. Cl. B01D 11/02; B01F 3/12; G05D 9/00

(52) U.S. Cl. 422/261; 422/281; 422/106

(57) ABSTRACT

A diluent such as water is sprayed from a nozzle through a screen onto water soluble packages of chemical supported on the screen to produce a solution for treatment of a system. The solution falls into a reservoir and is recirculated through the nozzle onto the screen for a duration sufficient to dissolve a load of chemical into solution. The concentrated solution is dispensed to a system. The reservoir can be flushed into the system before recirculating solution to the nozzle for further chemical dissolving. Chemical-containing packages can be loaded at any time without system interruption. Chemical is supplied in powder or solid form.

### FIELD OF THE INVENTION

This invention relates to the dispensing of chemical containing liquids and more particularly to apparatus and methods for preparing a liquid chemical solution from a powdered or solid chemical for dispensing.

### BACKGROUND OF THE INVENTION

In the past, it has been known to prepare a liquid chemical solution from liquid, solid or powdered chemicals. For example, one form of preparing a dispensable liquid from a solid chemical product is disclosed in U.S. patent application Ser. No. 13/031,724 filed on Feb. 22, 2011 and entitled “SOLID CHEMICAL DISSOLVER AND METHODS”, which application is expressly incorporated herein by reference and is a part hereof. Other forms of dispensers are shown in U.S. Pat. Nos. 2,371,720; 3,383,178; 3,595,438; 4,858,449; 4,964,185; 5,137,694; 6,441,073; 6,418,958 and 6,820,661 and in U.S. Published patent applications as US2007/0269894 and US2010/0025338. Each of these patents and publications is expressly incorporated herein by reference and is a part hereof.

Where it is desired to produce a dispensable, chemical containing liquid from chemicals in powdered form, as opposed to a liquid form, the powdered form chemicals may have several inherent disadvantages. For example, the powder may not be readily dissolvable in water. The powder may take a comparatively longer time to dissolve in water, as opposed to a liquid chemical form, in order to prepare a concentrated solution strong enough for any system which requires consistent doses. Prior devices thus typically feed a less concentrated solution, or use stronger, ready-made solutions. Some prior devices of the continuous feed variety require the powder dissolver to be turned off in order to recharge. Moreover, chemical concentrates in liquid form for use in the ready-made devices can be hazardous to handle with undesirable exposure consequences.

Also, the dissolving of certain chemicals in powdered form can produce fumes which are at best unpleasant.

Accordingly, it has been one objective of the invention to provide apparatus and methods for dissolving chemicals in powdered form to produce a dispensable liquid chemical concentrate solution in sufficient strength for use in a variety of treatment systems, particularly in those requiring small doses.

Another objective of the invention has been to provide a chemical powdered dissolver which does not require stoppage in order to recharge.

A related objective has been to produce a chemical powder dissolver which accommodates the addition of chemicals in powdered form without interruption of a dosing operation for which the dissolver is used.

A further objective of the invention is to provide a chemical powder dissolver for receiving chemical powder in discrete packages for introduction intact into the dissolver and thus eliminating the chance of undesirable contact of the chemical with a human operator.

A yet further objective of the invention has been to provide a chemical powder dissolver which prevents or substantially reduces the escape of gases from the powder dissolving process.

In addition to the foregoing, it will be appreciated that even where the chemical is concentrated in a disk, pellet or other solid form, several of the above described problems may be presented, such as the difficulty in presenting, then dissolving the chemical pursuant to spray from a nozzle in order to produce a solution of sufficient concentration for use in treating a water system, for example.

Accordingly, it has been yet a further objective of the invention to provide apparatus and methods for dissolving chemicals presented in either a powered or solid format into a dispensable solution of sufficient concentrate or strength for use in a variety of treatment systems.

### SUMMARY OF THE INVENTION

To these ends, a preferred embodiment of the invention includes a chemical container for receiving discrete water soluble packages of chemical in either powder or solid form. For one example, powdered biocides may be used as well as solid inhibitors. The packages rest on a support screen at least proximate to, and preferably at, the bottom of the container. A water spray nozzle is directed toward the screen, so that spray through the screen dissolves the packages, then the powder therein, with concentrated solution and any small, undissolved particles falling into a solution reservoir, which is initially full of fresh water. The solution in the reservoir is recirculated by a pump back to the nozzle and again sprayed through the screen onto the packages of powder and then with the chemical concentration of the solution increasing with time.

The recirculation pump operates for a predetermined time duration sufficient to provide a dispensable solution of desired chemical concentration for dispensing. Recirculation serves to further dissolve powder not dissolved upon first contact with the water and to increase the strength of the solution. Upon time out of the recirculation pump, a dispensing pump operates to deliver the chemical concentrated liquid to the system being treated and at the rate desired.

Once a low level of solution is detected in the reservoir, the dispensing pump stops and a fill solenoid valve is opened to refill the reservoir. This valve closes upon sensing of a full level in the reservoir, and recirculation can begin again. Water soluble packages of chemical powder are replenished as needed.

The invention may dispense slug doses of chemical solution intermittently with dormant periods of several days. There may be chemical solution or residue remaining in the reservoir after a dispensing cycle is completed, in which case the reservoir is refilled and the dispensing pump is run again, emptying the reservoir of the fresh water into the system being treated for flushing the reservoir to prevent and reduce fumes emanating from the residue. Rinsing can be repeated several times.

Suitable controls are provided to run the apparatus and provide appropriate warnings for malfunctions of the fill, dispense or recirculation cycles.

Accordingly, in one embodiment of the invention, chemical powder in water dissolvable packages is exposed to a water spray from a reservoir with the diluted and dissolved chemical falling back into the reservoir. Spray from the reservoir of the solution is recirculated for a controlled time to fully dissolve the powder into the solution which is then introduced into a system for treatment. Thus the chemical powder is delivered to the dissolver in packaged form without human contact, recirculating spray sufficiently dissolves the chemical into a solution of increasing and sufficient strength for use in a system, powder packages can be recharged into the dissolver without breaking or making any pump or line connections or stopping a dispensing cycle, and off gassing of any residue is reduced or eliminated. Alternately, the recirculating spray is directed onto chemical in solid form, packaged or not, with resulting dissolving and increasing solution strength.

These and other objectives and advantages will be readily appreciated from the following written description and from the drawings in which:

### BRIEF DESCRIPTION OF THE DRAWINGS

FIG. 1 is a graphic depiction of a flow chart according to the invention;

FIG. 2 is an isometric view of the invention taken of its front side;

FIG. 3 is a top plan view of the embodiment of FIG. 2;

FIG. 4 is an isometric view of the backside of the invention of FIGS. 1-3 with portions cutaway for clarity and the charcoal filter removed;

FIG. 5 is a back elevational view of the invention of FIGS. 2-4 with portions broken away for clarity;

FIG. 6 is a cross-sectional view of the invention of FIGS. 2-5 taken alone lines 6-6 of FIG. 3;

and

FIG. 6A is a diagrammatic illustration of the two component screens of the invention.

### DETAILED DESCRIPTION OF THE INVENTION

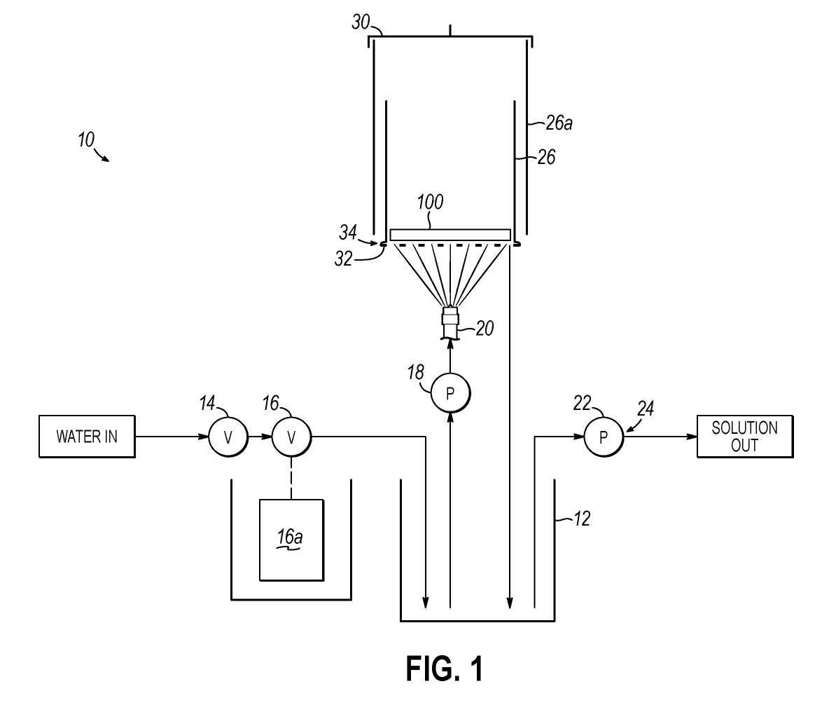

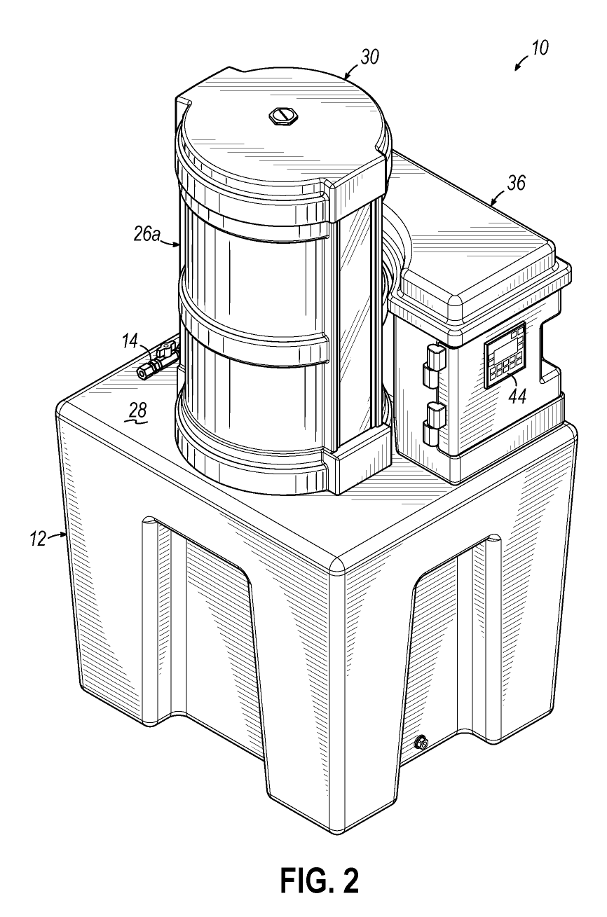

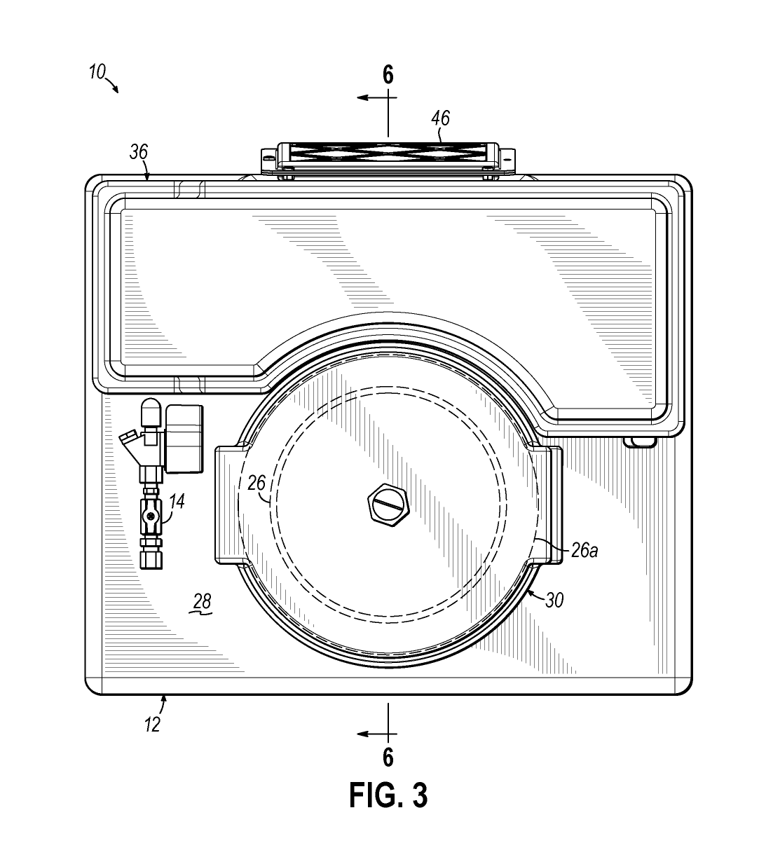

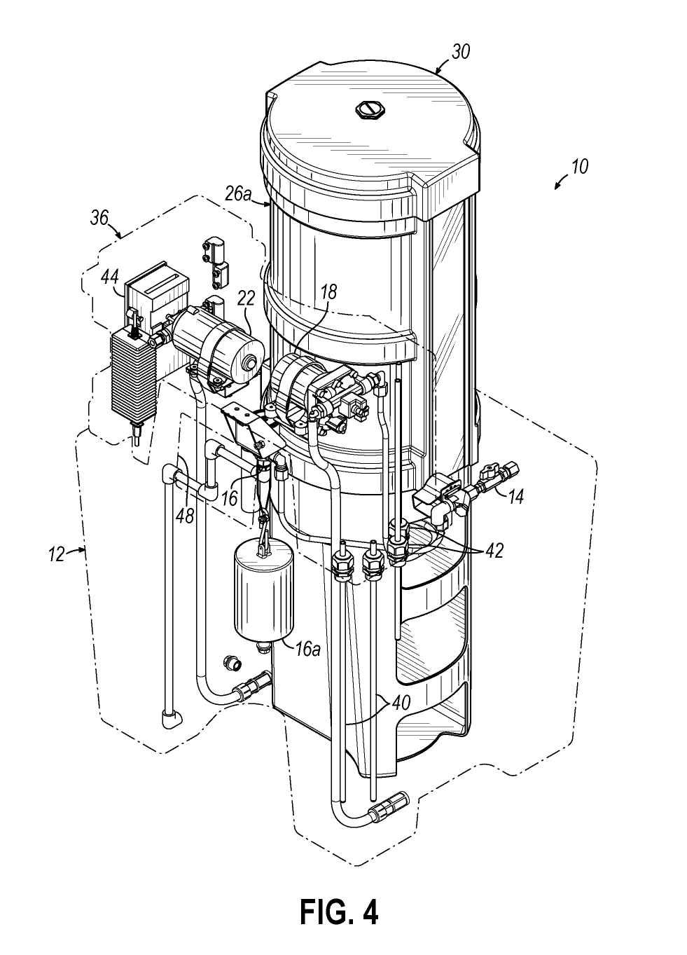

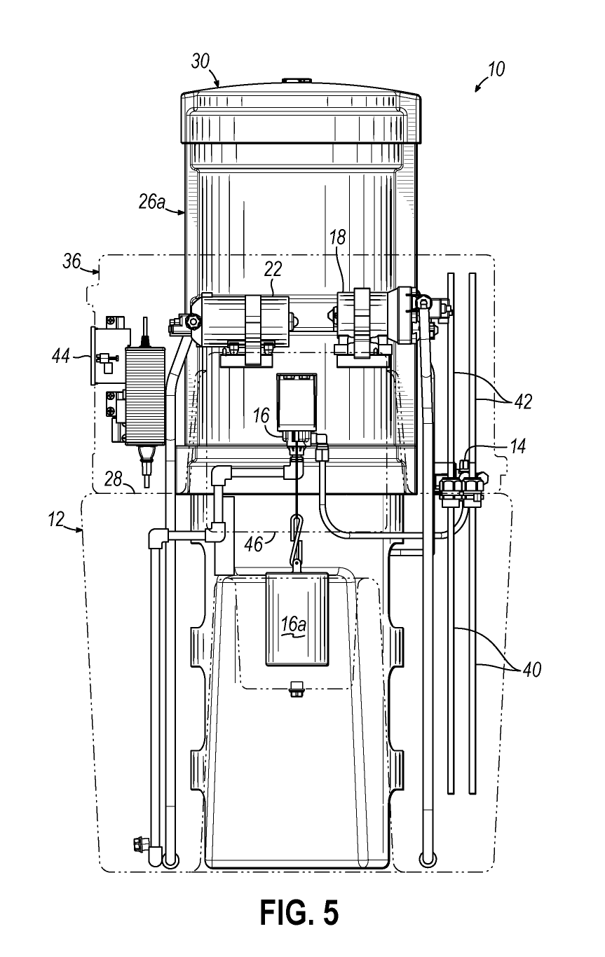

Turning now to the figures, there is shown in FIG. 1 flow chart for a powder dissolving dispenser 10 according to the invention. Dispenser 10 includes, without limitation, a reservoir 12 for containing, first, a diluent such as fresh water, then the solution while it is being mixed and dispensed. A solenoid actuated water inlet valve 14 can be opened to first fill the reservoir 12. A float 16a operated backup mechanical shutoff valve 16 is provided in the event the inlet valve 14 fails in its open position and would otherwise allow reservoir 12 to overflow.

Pump 18 is disposed in pump housing 36 and is operably connected between the solution in reservoir 12 and a spray nozzle 20 to recirculate the solution for mixing. For dispensing, a dispensing pump 22 is also disposed in housing 36 and is operably connected to the solution to pump the mixed solution to a dispensing outlet 24.

A receptacle 26 in housing 26a extends upwardly from housing or cover 28 of reservoir 12 for receiving a plurality of water dissolvable packages 100 of chemical in powder or solid form therein, or in individual discrete solid forms without package coverings.

Packages 100 in one embodiment are made of any suitable water dissolvable material. When dissolved, chemical, such as chemical powder therein is exposed. Receptacle 26 is of any suitable size, preferably large enough to hold one hundred packages 100 of about one pound weight each. Receptacle 26 is preferably covered with a removable top 30 which can be removed to allow more packages filled into receptacle 26 without removing any packages 100 therein and without stopping the dispensing operation, or requiring any pump or water or solution line disconnects. Packages 100 or solid forms can be of any size and shape, that shown in the FIGS. being exemplary only.

A screen 32 is operably located preferably at and across the bottom 34 of receptacle 26. Packages 100, and any powder exposed from a dissolved package 100, are disposed on and above screen 32. Nozzle 20 is oriented to spray upwardly onto and through screen 32 and thus onto packages 100 in receptacle 26 and onto exposed powder above the screen 32. First water, then recirculating solution, is sprayed through nozzle 20 onto and through screen 32. Exposed powder from one or more packages 100 is engaged by the water, then solution, which at least further dissolves portions of the powder and, carrying undissolved powder, then falls back into reservoir 12 from where pump 18 recirculates the solution to nozzle 20, further spraying the solution onto and through screen 32 to further dissolve packages 100 and powder therein, carrying the powder into the solution in reservoir 12. This recirculation of solution serves to further mix and dissolve the powder into solution. After predetermined time consistent with the duration of recirculation to sufficiently dissolve the powder into a desired strength of solution, the dispensing pump 22 is operated to discharge the solution in reservoir 12 through dispenser outlet 24 and to a system to be treated with the solution.

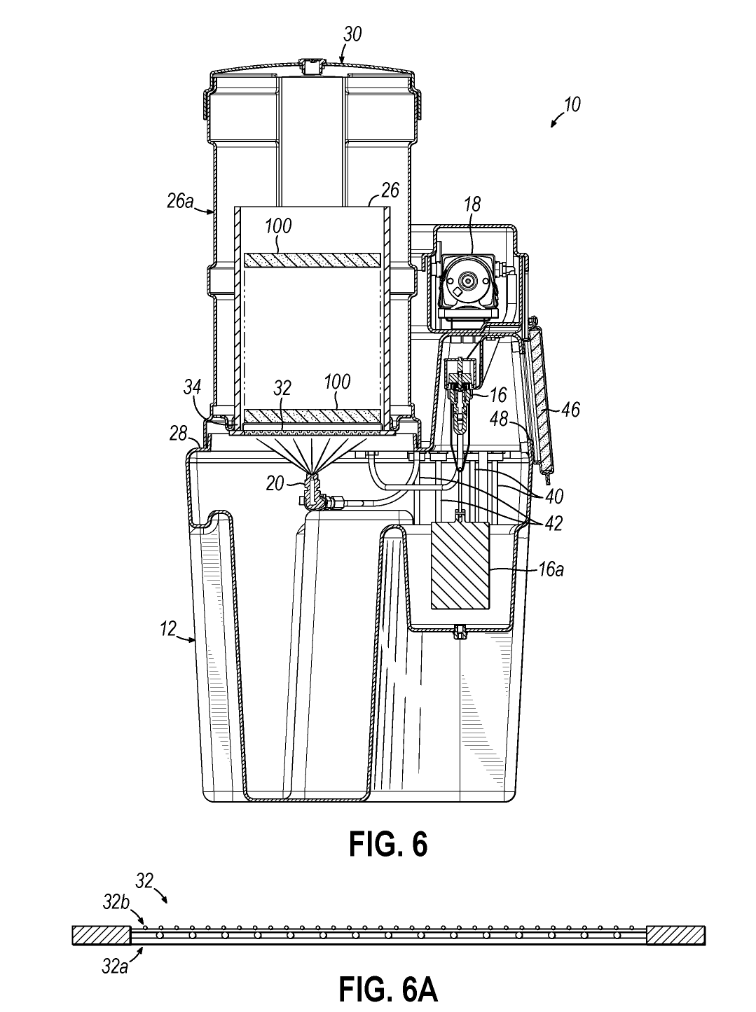

Screen 32 (see FIG. 6A) is preferably comprised of two screening components, a first metalized support screen 32a having a relatively open mesh of 2 to 4 wires per inch, for example, and a second screen or fabric 32b having a more closed mesh, such as 40 to 80 wires per inch, and preferably a 60 mesh. This second screen or fabric 32b may be comprised of woven stainless steel wires supported by the first screen underneath. Water or solution from nozzle 20 is sprayed onto and passes through screen 32, with the first screen element 32a of more open mesh supporting the second screen element 32b of more closed mesh, such that the chemical is supported on screen 32 but sufficiently exposed to the spray from nozzle 20 for dissolving and passing through screen 32 back into the reservoir for increasing the solution strength therein.

The mesh size of the second, more closed mesh screen component 32b is selected to optimize the passage of water but is small enough to block passage of significantly undissolved powder granules.

Preferably there are provided two conductive probe pairs 40, 42. Pair 40 is positioned to detect a low or empty solution level. Pair 42 is adjustable for detecting high or full solution level. Suitable volume or level sensors can be used, however, one useful system of useful probe pairs is further described in pending U.S. patent application Ser. No. 13/164,878 filed Jun. 21, 2011 entitled “SYSTEM AND METHOD FOR PRODUCT LEVEL MONITORING IN A CHEMICAL AND DISPENSING SYSTEM” hereby incorporated in its entirety by this reference as if fully set forth herein.

An electronic controller 44 of any suitable type is operably connected and programmed to operate the system and sequence of operations as described herein.

Housing 28 also operates to contain potential fumes produced by the mixed solution or residue in reservoir 12. A charcoal filter 46 is preferably placed over vent 48 from housing 28 to collect and capture such fumes.

### OPERATION

The mixing/dispense cycle in one embodiment begins with the reservoir 12 full of fresh water and the chemical holder 26 full of the chemical to be dispensed. In one embodiment, up to 25 gallons of water at 50 to 90 degrees Fahrenheit is in reservoir 12, with 50 one pound packages 100 of powder, such as granular biocide product, in receptacle 26. As stated, other size packages can be used, as well as solid chemicals such as, for example, up to 100 pound solid inhibitor material or other weights thereof.

The start of the mixing/dispense cycle is triggered either by an external signal or the controller 44 which includes a timer so dispenser 10 mixes then feeds the chemical solution at predetermined times. Up to 25 gallons of solution gets fed to the system to be treated per cycle. This solution will be from 0.5 to 10% concentrate at 50 to 90 degrees Fahrenheit.

The cycle starts by running the recirculation pump 18 for a programmed time, such as for 120 minutes, for example, even if powder above the screen has already been exhausted. Other recirculation times or periods may be appropriate for different chemicals. This pump draws solution from the filled reservoir and discharges it through the spray nozzle 20. The spray strikes the screen 32 covering the bottom of the chemical holder 26. After the solution strikes the screen and the bottom of the chemical, the solution flows back into the reservoir. Other run times and volumes can be selected, depending on the chemical, the form, the packages and the solution concentration desired.

When the mixing time has expired, the recirculation pump 18 stops and the dispensing pump 22 starts. Up to 25 gallons of solution at 50 to 90 degrees Fahrenheit, in this embodiment, is dispensed to a system to be treated through dispenser outlet 24.

The dispense pump 22 draws solution from the reservoir 12 and feeds it through outlet 24 into the system being treated.

When the “low level” probe detects that the reservoir is empty, the dispense pump 22 stops and the fill solenoid valve 14 is opened to refill the reservoir. Water fills to a level up to about 25 gallons at 50 to 90 degrees Fahrenheit.

When the “full level” probe 42 detects that the reservoir 12 is full, the fill solenoid valve 14 closes. If valve 14 fails to close, backup shutoff valve 16 operates to stop water flow into reservoir 12.

There is typically some chemical residue in the reservoir 12 at this time. This solution can produce fumes. After the reservoir is refilled, the dispense pump 22 can be run again to flush and empty the reservoir into the system being treated. This rinsing cycle may need to be repeated. The reservoir is then refilled with about 25 gallons of water supply temperature. Sometimes the water used to dissolve the chemical is very cold. Warmer water, such as at 50 to 90 degrees Fahrenheit, aids the dissolving of the chemicals used in this device. The reservoir is finally filled with water at the end of the dispense cycle to give the water time to warm to within a preferred temperature range.

The typical use of this dispenser 10 in one embodiment is to dispense solution intermittently as scheduled, up to a total 25 gallons of solution at 0.05 to 50% strength at 50 to 90 degrees Fahrenheit. Typically a dispense operation may occur, for example, intermittently over one day and preferably every few days.

It will be appreciated that the size of dispenser 10 can be varied to fit particular applications. For example, the dispenser 10 may be about four feet or so in overall height, with powder container 26 about 15 inches tall and 10 inches in inside diameter, and housing 26a about 27 inches tall, reservoir 12 about two feet tall and reservoir 12 about two feet square or slightly rectangular. Size variations are within the scope of the invention.

Indeed, even if mixing or dispensing is stopped as a safety protocol for chemical loading, it will be appreciated that no water or pump connects need be broken or modified to refill the reservoir, in order to accommodate further chemical loading.

It will be appreciated that it is not necessary to stop mixing or dispensing in order to add more chemical to receptacle 26, however, that may be preferred. It is appreciated that it is not necessary to stop dispensing in order to add more chemical to receptacle 26. Nor is it necessary to break or make any fluid connection or lines for introducing fresh chemical to receptacle 26 during dispensing. Also, it will be appreciated that a variety of treatment chemicals can be so dissolved into solution at different concentrations or strength and sufficiently mixed and dissolved into solution as desired. Thus, recirculation duration, water volume, powder volumes and dispensing timing, as well as the sizes, pump output and other parameters can all be varied to achieve a desired result, and all without handling of chemical powder and without handing of solution. Spills and undesirable human contact are eliminated, and a variety of chemical solutions, processes and treatment steps are available.

What is claimed is:

1. Apparatus for dissolving chemical into a solution for treatment of a system and comprising:
a reservoir;
a chemical receptacle;
a screen above the reservoir in operable association with the receptacle for supporting chemical thereon;
a spray nozzle oriented to spray a diluent onto said screen, with a mix of diluent and chemical falling from said screen into said reservoir;
a pump for recirculating solution of increasing chemical concentrate from said reservoir to said nozzle for spray onto said screen and for a predetermined time duration; and
a second pump for dispensing solution of diluent and chemical to said system.

2. Apparatus as in claim 1 further including a first valve for passing diluent to said reservoir when open.

3. Apparatus as in claim 1 further including a plurality of water soluble packages containing chemical in powder form within said receptacle.

4. Apparatus as in claim 3 further including a solution level sensor operably associated with said reservoir for signaling when said reservoir is full and said valve closing in response to said signaling.

5. Apparatus as in claim 4 further including a second backup level sensor for sensing a filled condition of said reservoir and a backup valve for shutting off diluent flow to said reservoir upon failure of said first valve to close.

6. Apparatus as in claim 1 wherein said screen is disposed at least proximate a lower end of said receptacle.

7. Apparatus as in claim 6 wherein said chemical is in powered form and is contained in discrete water soluble packages supported on said screen.

8. Apparatus as in claim 6 wherein said chemical is in solid form.

9. Apparatus as in claim 1 including a sensor for sensing an empty condition of said reservoir after said dispensing.

10. Apparatus as in claim 1 wherein said pump for recirculating solution is operable to recirculate solution when no powder is in said receptacle.

11. Apparatus as in claim 1 wherein said reservoir is disposed in a housing having a vent, and said apparatus further including a filter operably disposed with respect to said vent to capture fumes from said reservoir.

12. Apparatus as in claim 1 wherein said screen includes a first screen element of one mesh size and a second screen element of a smaller mesh size.

13. A method of dissolving chemical in powder or solid form into a solution for treating a system, said method comprising:
introducing said chemical into a receptacle;
supporting said chemical on a screen;
spraying water from a nozzle onto said screen and carrying chemical into solution falling from said screen;
collecting said solution in a reservoir;
recirculating solution of increasing chemical concentration from said reservoir to said nozzle and spraying solution onto said chemical through said screen;
continuing said recirculation to dissolve chemical into said solution; and
dispensing solution from said reservoir to a system to be treated.

14. A method as in claim 13 including recirculating said solution from said reservoir to said nozzle to said screen, and back to said reservoir for a predetermined time and dispensing said solution after said time.

15. A method as in claim 15 including the step of filling said reservoir with water to a filled condition.

16. A method as in claim 15 further closing a water inlet valve and first ceasing said filling in response to sensing of said filled condition.

17. A method as in claim 16 including shutting off water flowing to said reservoir in the event of failure of said first ceasing step.

18. A method as in claim 14 including ceasing said dispensing in response to detecting an empty reservoir.

19. A method as in claim 14 including continuing said recirculation in the absence of chemical above said screen.

20. A method as in claim 13 including introducing chemical to said receptacle in discrete water soluble packages.

21. A method as in claim 20 including introducing said packages into said receptacle while said water is sprayed onto said screen.

22. A method as in claim 13 wherein said dispensing step includes intermittently dispensing at least a portion of said solution intermittently.

23. A method as in claim 22 wherein said dispensing step includes intermittently dispensing portions of up to 25 gallons of said solution at 0.05% to 50% strength.

24. A method as in claim 23 wherein said dispensing includes dispensing solution at about 50 to 90 degrees Fahrenheit.

25. A method as in claim 22 wherein said intermittent dispensing is carried out over a period of more than one day.
